(19) United States
(12) Patent Application Publication
(10) Pub. No.: US 2004/0084958 A1
(43) Pub. Date: May 6, 2004

(54) Element for brake actuator

(75) Inventors: Fumiyoshi Ariki, Asahi-machi (JP); Hiroyuki Shinkai, Asahi-machi (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/622,716

(22) Filed: Jul. 21, 2003

(30) Foreign Application Priority Data
Jul. 22, 2002 (JP) 2002-212469

(51) Int. Cl. B60T 8/40

(52) U.S. Cl. 303/116.1; 303/DIG. 11

(57) ABSTRACT

A brake actuator element used in a hydraulic brake system and exposed to brake fluid. It includes a piston formed with a not-through hole, and a pin pressed into the piston. A channel is defined between the inner wall of the not-through hole and the outer periphery of the pin. Through this passage, the gap defined between the bottom of the pin and the bottom of the not-through hole when the pin is pressed into the not-through hole is always kept in communication with the outer air. Thus, any air remaining in the gap smothly escapes through the channel when the pin is pressed into the not-through hole.

### BACKGROUND OF THE INVENTION

This invention relates to an element for use in a brake actuator comprising a first member and a second member pressed into the first member.

FIG. 5 shows a known hydraulic brake system which is disclosed in JP patent publication 2000-54968. It includes a reservoir 10 for storing brake fluid discharged from wheel cylinders 7 during pressure reduction phase and supplying the brake fluid to a pump 8 when the pump is activated.

The reservoir 10 includes a shut-off valve 14 for opening and closing a line extending between an output port of a master cylinder 3 and a fluid chamber A of the reservoir 10. The shut-off valve 14 opens to supply the brake fluid from the master cylinder 3 when the amount of brake fluid supplied from the reservoir 10 to the pump 8 is insufficient, and closes when the amount of fluid stored in the reservoir 10 has exceeded a predetermined amount, thus stopping the flow of brake fluid from the master cylinder 3 to the reservoir 10. In FIG. 5, the brake system includes a brake pedal 1, a booster 2, a linear differential pressure control valve 4, an intensified pressure control valve 5, a pressure reduction control valve 6 and a check valve.

FIG. 6 shows the reservoir 10 and the shut-off valve 14 in detail. The reservoir 10 includes a piston 12 slidably received in a housing 11 and defining a fluid chamber A and an atmospheric chamber B. The piston 12 is biased toward the fluid chamber A by a spring 13 mounted in the chamber B.

The shut-off valve 14 comprises a pin (or pushrod) 15 fixed to the piston 12, a ball valve 16 and a valve seat 17 on which the ball valve 16 is adapted to be seated.

For ease of manufacture, the pin 15 is separately made from the piston 12 and pressed into the piston.

In one conventional arrangement, such a pin 15 is pressed into a through hole 18 formed in the piston 12 as shown in FIG. 7. In this arrangement, brake fluid in the fluid chamber A may leak through a gap between the hole 18 and the pin 15. Also, due to the fluid pressure in the chamber A, the pin 15 may be pushed out of the hole 18 into the chamber B. This decreases reliability of the brake system.

The arrangement of FIG. 8 is free of these problems because in this arrangement, the pin 15 is pressed into a not-through hole 19 formed in the top surface of the piston 12. But this arrangement poses another problem in that when the pin 15 is pressed into the not-through hole 19, air tends to be trapped in the space between the bottom of the pin and the bottom of the hole 19. During use, the trapped air may gradually leak into brake fluid. Also, since the trapped air is compressed when the pin is pressed into the hole 19, the pin 15 may be pushed out of the hole 19 during use under the pressure of the compressed air.

Even a small amount of air mixed into brake fluid will worsen the brake feel and also actually lower the braking force because the force applied to the brake pedal by the driver is at least partly used to compress the air. This is what is called “sponge brake”.

Brake actuator elements to which the concept of this invention is applicable includes, besides the pin-and-piston element shown, one comprising a piston and a valve body pressed into the piston and one comprising a housing and a stopper pin pressed into the housing. Any of these elements are used with its member pressed into the other member under hydraulic brake fluid.

An object of the invention is to provide a brake actuator element including a first member and a second member pressed into the first member which is free of any of the abovementioned problems, thereby improving the performance.

### SUMMARY OF THE INVENTION

According to the invention, a first member or a second member pressed into a not-through hole formed in the first member has a channel through which the not-through hole communicates with the outer air.

The channel may be defined by a cylindrical surface of the second member and a flat cut surface formed on a portion of the second member pressed into the not-through hole.

Also, the channel may be a groove formed in the inner periphery of the not-through hole or in the outer periphery of the second member.

The bottom of the second member and the bottom of the not-through hole may be shaped so as to contact each other only at central portion of the not-through hole with the edge of the bottom of the pin spaced from the bottom of the not-through hole when the second member is pressed into the not-through hole. With this arrangement, brake fluid can smoothly flow into the bottom of the hole through the channel while expelling any remaining air.

When the second member is pressed into the not-through hole, any air present between the bottom of the not-through hole and the bottom of the second member is smoothly expelled through the channel. Thus, air will not be trapped in the bottom of the hole. This prevents the second member from being pushed out of the hole under air pressure.

During evacuation of the brake hydraulic circuit, brake fluid flows through the channel into the bottom of the not-through hole, replacing non-compressed air. Thus, air remains little in the bottom of the not-through hole. This prevents air from leaking into brake fluid during use.

### BRIEF DESCRIPTION OF THE DRAWINGS

Other features and objects of the present invention will become apparent from the following description made with reference to the accompanying drawings, in which:

FIG. 1A is a sectional view of a brake actuator element embodying the present invention;

FIG. 1B is a plan view of the same;

FIG. 2 is a sectional view of another example of the channel;

FIG. 3 is an enlarged sectional view of another embodiment in which the not-through hole has a concave conical bottom;

FIG. 4 is an enlarged sectional view of still another embodiment, which comprises a not-through hole having a convex conical bottom and a pin having a convex conical bottom;

FIG. 5 is a circuit diagram of an entire hydraulic brake system to which the present invention can be applied;

FIGS. 6 and 7 are sectional views of conventional reservoirs which can be used in the brake system of FIG. 5;

FIG. 8 is a sectional view of another conventional arrangement; and

FIG. 9 is a sectional view showing the problem of a conventional arrangement.

### DETAILED DESCRIPTION OF THE PREFERRED EMBODIMENT

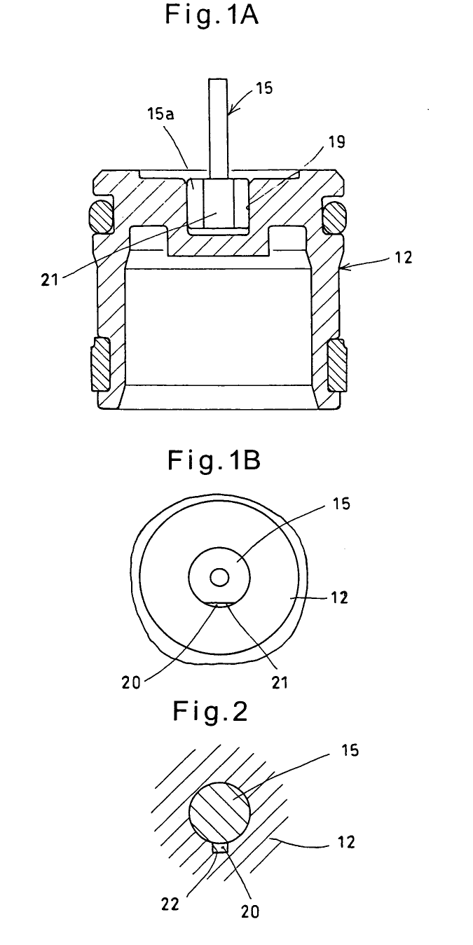

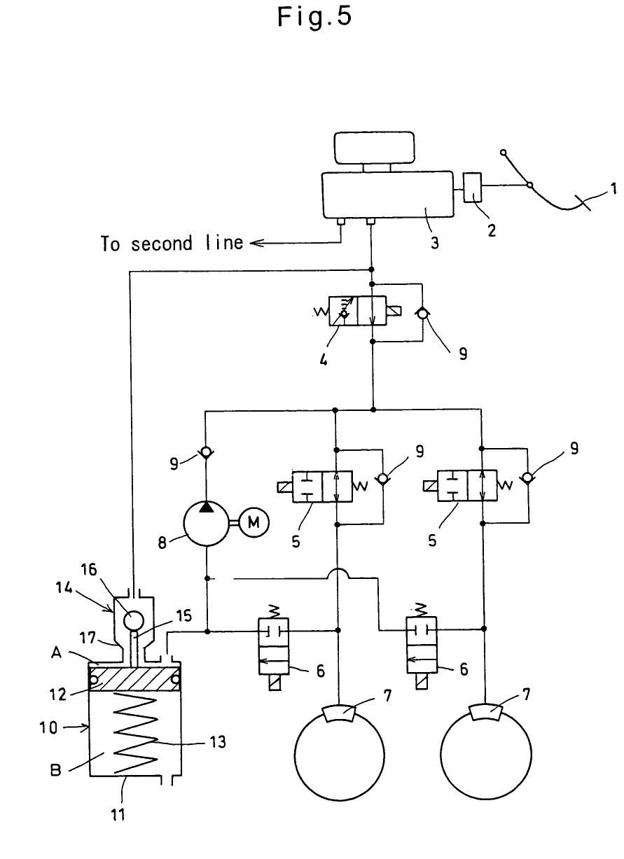

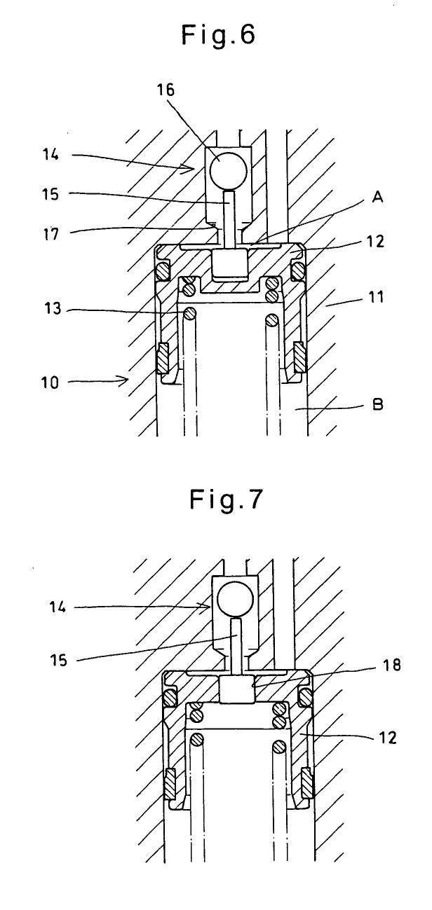

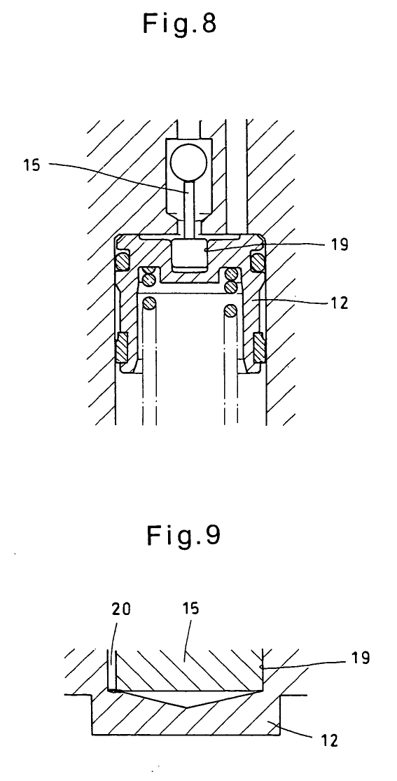

Now referring to FIG. 1, the brake actuator element of this embodiment comprises a piston used in a reservoir of the type described with reference to FIGS. 5-8, and a pin pressed into the piston.

The pin 15 is pressed into a not-through or blind hole 19 formed in the top surface of the piston 12. An axial channel 20 is defined between the inner periphery of the not-through hole 19 and the outer periphery of the pin 15. When the pin is pressed into the not-through hole 19, air in the gap between the bottom of the pin and the bottom of the not-through hole will escape through the channel 20. Thus, when the pin is fully pressed into the hole 19, any air remaining in this gap and the channel 20 is under the atmospheric pressure.

Thus, when the brake fluid is introduced into the reservoir while evacuating the brake hydraulic circuit, any air remaining in the gap and the channel will be replaced with brake fluid and discharged.

In the embodiment of FIG. 1, the channel 20 is defined by the cylindrical inner surface of the not-through hole 19 and a flat cut surface 21 formed on the outer periphery of a boss portion 15a of the pin 15 which is pressed into the hole 19. The cut surface 21 extends the entire length of the boss portion 15a. The channel 20 of the embodiment shown in FIG. 2 is an axial groove 22 formed in the inner periphery of the not-through hole 19. While not shown, such a groove 22 may be formed in the outer periphery of the boss portion 15a.

If the not-through hole 19 is formed by use of an ordinary drill, a concave conical bottom will be formed as shown in FIG. 9. When the pin 15 is pressed into such a not-through hole 19, the bottom edge of the pin 15 may be crushed if large force is applied to the pin. If the bottom edge of the pin is crushed, the bottom of the channel 20 may close up, thus trapping air in the gap between the bottom of the pin and the bottom of the hole 19. Such trapped air is not discharged by evacuation, but may gradually bleed into brake fluid. Thus, measures should be taken to prevent the bottom of the channel from closing up.

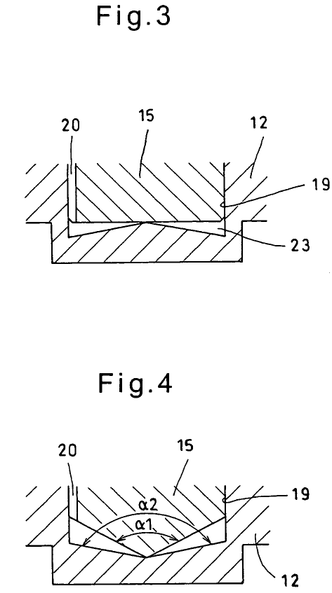

FIGS. 3 and 4 show such measures.

That is, the not-through hole 19 of FIG. 3 has a convex conical bottom so that the pin 15 contacts the bottom of the hole at its central portion only and a gap 23 will be formed. This prevents the bottom edge of the pin from being crushed and thus the channel from closing up. Brake fluid thus smoothly flows into the channel and the gap 23 at the bottom of the hole 19 during evacuation of the brake hydraulic circuit.

In FIG. 4, the not-through hole 19 has a concave conical bottom having an apex angle a 2 while the pin has a convex conical bottom having an apex angle a 1 that is smaller than a 2 so that the bottom edge of the pin 15 is spaced from the bottom of the hole 19 with a gap 23 is formed. This arrangement has the same effect as the arrangement of FIG. 3.

Other measures include a combination of a convex conical bottom of the not-through hole 19 and a concave conical bottom of the pin having different apex angles and a protrusion formed on the center of the bottom of the pin or the hole. Such arrangements, too, have similar effects. Among these measures, the one shown in FIG. 4 is the most preferable in workability.

The brake actuator elements shown in the drawings are all used in a reservoir and comprise a piston and a pin pressed into the piston. But the present invention encompasses not only such brake actuator elements but also any brake actuator element exposed to brake fluid in an actuator.

According to this invention, it is possible to prevent leak of brake fluid through the brake actuator, prevent the second member from coming out of the not-through hole formed in the second member, and prevent air from bleeding into brake fluid and thus impairing brake action and brake feeling. This improves performance and reliability of the hydraulic brake system.

What is claimed is:

1. An element for use in a brake actuator, said element being mounted so as to be always in contact with hydraulic brake fluid in a brake fluid pressure circuit, said element comprising a first member formed with a not-through hole having a bottom, and a second member having a bottom and pressed into said not-through hole, one of said first member and said second member being formed with a channel through which any gap present between said bottom of said pin and said bottom of said not-through hole is in communication with the outside of said not-through hole.

2. The element claimed in claim 1 wherein said channel is defined by a cylindrical inner periphery of said not-through hole and a flat cut surface formed on the outer periphery of a portion of said second member which is pressed into said hole.

3. The element of claim 1 wherein said channel is a groove formed in one of the outer periphery of said second member and the inner periphery of said not-through hole.

4. The element of any of claims 1-3 wherein said bottom of said second member and said bottom of said not-through hole are shaped so as to contact each other only at central portion of said not-through hole with the edge of the bottom of said pin spaced from the bottom of said not-through hole when said second member is pressed into said not-through hole.

5. The element of claim 4 wherein the bottom of said not-through hole has the shape of a concave cone.

6. The element of claim 4 wherein one of the bottom of said second member and the bottom of said not-through hole has the shape of a concave cone having a first apex angle, and the other of the bottom of said second member and the bottom of said not-through hole has the shape of a convex cone having a second apex angle, said first apex angle being different from said second apex angle.
